(19) United States
(12) Patent Application Publication
(10) Pub. No.: US 2026/0339728 A1
(43) Pub. Date: Oct. 29, 2026

(54) SYSTEM AND METHOD FOR AUTONOMOUS CLOUD INFRASTRUCTURE MANAGEMENT USING ARTIFICIAL INTELLIGENCE

(71) Applicants: Venkatramana Reddy Panyala, Matthews, NC (US); Manoj Singireddy, Naperville, IL (US); Ashok Kumar Narava, Little Elm, TX (US)

(72) Inventors: Venkatramana Reddy Panyala, Matthews, NC (US); Manoj Singireddy, Naperville, IL (US); Ashok Kumar Narava, Little Elm, TX (US)

(21) Appl. No.: 19/705,858

(22) Filed: Jun. 12, 2026

(51) Int. Cl. G06F 9/50; G06N 20/00

(52) U.S. Cl. CPC G06F 9/5027; G06N 20/00

(57) ABSTRACT

A system and method for autonomous cloud infrastructure management are disclosed. The system includes a data collection module configured to obtain operational data from cloud computing resources and a behavioral fingerprinting module configured to generate dynamic representations of resource behavior using machine learning techniques. An anomaly detection module identifies deviations from expected operational patterns across multiple time scales. A resource optimization module dynamically allocates computing resources based on predicted demand to improve utilization and reduce latency. A self-healing module performs automated remediation actions including fault detection, diagnosis, and corrective execution. The system further includes a federated learning module configured to update machine learning models across distributed environments without sharing raw data. The disclosed system improves reliability, scalability, and efficiency of cloud computing environments through proactive monitoring and adaptive resource management.

### FIELD OF INVENTION

The present disclosure relates generally to cloud computing systems and distributed computing environments, and more particularly to systems and methods for autonomous cloud infrastructure management using artificial intelligence for dynamic resource optimization, anomaly detection, and automated remediation of cloud-based computing resources.

### BACKGROUND

Cloud computing environments form the backbone of modern distributed computing systems, providing scalable and on-demand access to computational resources including virtual machines, containerized workloads, storage systems, and network infrastructure. These resources are typically deployed across geographically distributed data centers and often span multiple cloud service providers in hybrid or multi-cloud configurations. Management of such cloud infrastructure involves complex operations including resource provisioning, workload scheduling, performance monitoring, fault detection, scaling, and system recovery.

Conventional cloud management systems employ a combination of manual administration, rule-based orchestration frameworks, and threshold-triggered monitoring mechanisms to manage these operations. Certain prior art systems have attempted to improve cloud infrastructure management through automation and analytical techniques. For example, U.S. Patent Publication No. US2019/0234567 describes a cloud automation framework that utilizes agent-based monitoring and predefined rule sets to perform resource scaling, configuration management, and failure recovery. In such systems, operational data is collected from infrastructure components and processed using static logic to trigger predefined workflows. While these approaches enable automation of repetitive tasks, they are constrained by their reliance on manually defined rules and lack the ability to adapt dynamically to evolving system conditions or previously unseen operational patterns.

Similarly, European Patent No. EP3456789 discloses a cloud management system incorporating machine learning models for resource classification and performance prediction. Such systems utilize supervised learning techniques trained on historical datasets to identify resource types and estimate performance characteristics. Although these approaches introduce data-driven analysis into cloud management, their effectiveness is limited by dependence on labeled training data and predefined feature sets, thereby restricting their ability to generalize across heterogeneous and dynamically changing cloud environments. Despite these developments, existing cloud management systems exhibit several inherent technical limitations.

First, conventional systems primarily rely on static configuration data and discrete performance metrics, such as CPU utilization and memory usage, captured at periodic intervals. These approaches fail to represent the continuous, temporal, and relational behavior of cloud resources, including inter-service dependencies, communication patterns, and workload dynamics. As a result, such systems lack a comprehensive understanding of infrastructure behavior necessary for advanced optimization and fault prediction.

Second, resource allocation mechanisms in existing systems are predominantly reactive. Scaling decisions are typically triggered when monitored parameters exceed predefined thresholds, such as CPU or memory utilization limits. This reactive paradigm introduces latency between the onset of demand changes and the corresponding scaling response, leading to transient performance degradation, inefficient resource utilization, and potential service disruptions.

Third, anomaly detection mechanisms in current cloud management solutions are generally based on threshold-based alerts or simple statistical models. These techniques are insufficient for detecting complex anomalies characterized by multi-dimensional correlations, temporal dependencies, or gradual deviations from normal behavior. For example, coordinated anomalies involving multiple interacting services or slow-developing faults such as memory leaks may remain undetected until system performance is significantly impacted.

Fourth, management of multi-cloud and distributed environments remains technically challenging due to heterogeneity in cloud provider interfaces, resource abstractions, and operational models. Existing tools often provide fragmented visibility and limited interoperability, thereby preventing unified optimization and governance across diverse infrastructure components.

Fifth, existing systems lack fully autonomous remediation capabilities. Although certain automation frameworks can execute predefined recovery actions, they typically require human intervention for root cause analysis, decision-making, and execution of corrective measures. This dependence on human operators increases mean time to resolution (MTTR) and introduces variability in system recovery processes. Furthermore, current cloud management systems do not effectively leverage historical operational data to continuously improve system performance. While some systems incorporate limited adaptive mechanisms, they do not implement comprehensive learning architectures capable of refining models, optimizing decision strategies, and improving system behavior over time in a distributed and scalable manner.

Accordingly, there exists a need for improved systems and methods that provide intelligent, adaptive, and autonomous cloud infrastructure management. Such systems should be capable of continuously analyzing dynamic behavioral characteristics of cloud resources, predicting future system states, optimizing resource allocation proactively, detecting complex anomalies with high accuracy, and performing automated remediation actions with minimal human intervention, thereby enhancing performance, reliability, scalability, and efficiency of cloud computing environments.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to systems and methods for autonomous cloud infrastructure management using artificial intelligence for dynamic resource optimization, anomaly detection, and automated remediation of cloud-based computing resources.

In one embodiment herein, a system and method for autonomous management of a cloud computing environment that improves operational efficiency, resource utilization, and system responsiveness. In one aspect, a computing system including a processor and memory is configured to collect operational data from a plurality of cloud computing resources, including performance metrics, communication patterns, and execution characteristics. The system generates behavioral representations of the cloud computing resources based on the collected operational data, the behavioral representations capturing temporal and relational characteristics of resource behavior.

In one embodiment herein, the system further detects anomalies by identifying deviations between current operational behavior and the generated behavioral representations using one or more machine learning models. Based on the behavioral representations, the system predicts resource demand and dynamically allocates computing resources to accommodate anticipated workload conditions. In response to detected anomalies, the system automatically initiates remediation actions, including root cause determination, generation of remediation strategies, and execution of corrective actions, thereby reducing system downtime and improving reliability.

In certain implementations, the behavioral representations are generated using machine learning techniques including graph neural networks, recurrent neural networks, and attention-based models. The system is further configured to detect multiple types of anomalies, including transient, progressive, and structural anomalies. In another aspect, the system performs predictive scaling by forecasting workload demand using historical operational data and temporal behavior patterns, and allocates computing resources across multiple cloud service providers or geographic regions.

In another aspect, the system includes a federated learning module configured to train machine learning models across distributed environments and update global models using aggregated parameters without transferring raw operational data. In another aspect, the behavioral representations are continuously updated in real time based on incoming operational data. In another aspect, a method is provided for performing the above operations, including data collection, behavioral modeling, anomaly detection, resource prediction, dynamic allocation, and automated remediation without human intervention. The disclosed system and method provide technical improvements in cloud computing environments, including reduced latency, improved resource utilization, enhanced anomaly detection accuracy, and autonomous system recovery.

The system further implements a behavioral fingerprinting framework configured to generate continuous multi-dimensional representations of cloud resource behavior through a multi-stage processing pipeline including data acquisition, feature extraction, aggregation, and neural processing. The system further incorporates a hierarchical resource optimization architecture operating across multiple levels of abstraction including individual resource-level optimization, service-level scaling, and infrastructure-wide workload distribution. The system additionally implements a closed-loop self-healing mechanism comprising anomaly detection, root cause analysis, remediation strategy generation, execution of corrective actions, and post-remediation verification. Further, the system supports behavioral security validation through analysis of resource interaction patterns and detection of anomalous access or communication behavior. In certain embodiments, federated learning operations include aggregation of model updates across distributed environments to continuously improve system performance without transfer of raw operational data.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a system for autonomous management of a cloud computing environment, in accordance with embodiments of the invention.

FIG. 2 illustrates an autonomous cloud platform architecture for managing cloud computing resources using artificial intelligence-driven orchestration, optimization, monitoring, and self-healing mechanisms, in accordance with embodiments of the invention.

FIG. 3 illustrates a workflow architecture depicting data flow and operational processes for infrastructure provisioning, monitoring, anomaly detection, optimization, and automated remediation within the cloud computing environment.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

Cloud computing environments include distributed computing resources such as virtual machines, containers, storage systems, and networking components deployed across multiple regions and cloud service providers. These environments are characterized by dynamic workload conditions, heterogeneous infrastructure, and complex interdependencies among resources. Conventional cloud management approaches rely on rule-based automation, threshold-driven monitoring, and manual intervention for provisioning, scaling, and failure recovery. Such approaches typically utilize discrete performance metrics and static configuration data to monitor system behavior. However, these techniques provide limited visibility into the dynamic and temporal characteristics of cloud resource interactions and are unable to capture complex relationships among distributed components.

As a result, several technical challenges arise. Existing systems are generally reactive in nature, initiating scaling or recovery actions only after performance degradation or threshold violations have occurred. This reactive behavior introduces latency in response, leading to inefficient resource utilization and potential service disruption. Additionally, conventional anomaly detection techniques based on static thresholds or simple statistical models are inadequate for identifying complex, multi-dimensional anomalies, including gradual system degradation and interdependent failures across multiple resources.

Further, management of multi-cloud environments remains fragmented due to differences in provider architectures, interfaces, and operational models. This fragmentation limits the ability to perform unified optimization and coordinated control across distributed infrastructure. Moreover, existing systems often lack autonomous remediation capabilities and depend on human operators for root cause analysis and execution of corrective actions, thereby increasing system downtime and operational overhead. To address these technical challenges, the present disclosure provides a system and method for autonomous management of cloud computing environments. The system collects continuous operational data from cloud resources and generates behavioral representations that capture temporal patterns and inter-resource relationships. These representations enable a comprehensive understanding of infrastructure behavior beyond static metrics.

The system utilizes machine learning models to detect anomalies by identifying deviations from learned behavioral patterns, thereby improving detection accuracy for both abrupt and gradual anomalies. Based on the behavioral representations, the system predicts resource demand and dynamically allocates computing resources to match anticipated workload conditions, thereby improving resource utilization and reducing response latency

In addition, the system automatically initiates remediation actions in response to detected anomalies, including root cause identification, generation of corrective strategies, and execution of recovery operations without requiring human intervention. The system further incorporates federated learning mechanisms to continuously improve model performance across distributed environments while preserving data privacy. Accordingly, the disclosed system provides a technical improvement in cloud computing infrastructure management by enabling proactive resource optimization, accurate anomaly detection, and autonomous remediation, resulting in enhanced system reliability, scalability, and operational efficiency.

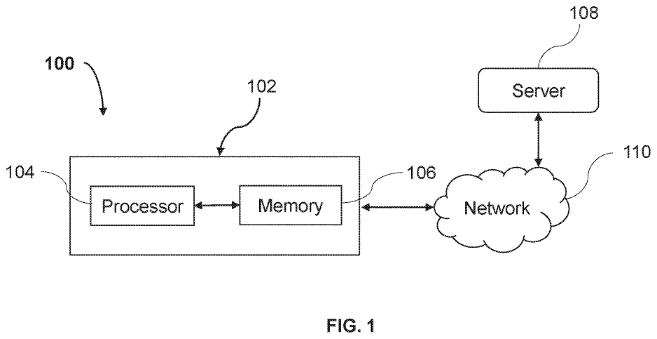

FIG. 1 refers to a block diagram of a system 100 for autonomous management of a cloud computing environment. In one embodiment, a system 100 for autonomous management of a cloud computing environment is provided. The system 100 comprises a computing device 102 including one or more processors 104 and a memory 106 storing one or more instructions executable by the one or more processors 104.

The one or more processors 104 are configured to collect operational data from a plurality of cloud computing resources. The cloud computing resources include virtual machines, containerized workloads, storage systems, and network components deployed across one or more cloud environments. The operational data includes performance metrics, communication patterns, and execution characteristics. The performance metrics include processor utilization, memory usage, network throughput, and input/output operations. The communication patterns include inter-resource communication, service dependencies, and network traffic flows. The execution characteristics include process execution states, workload behavior, and application runtime patterns.

The one or more processors 104 are further configured to generate behavioral representations of the plurality of cloud computing resources based on the collected operational data. The behavioral representations comprise multi-dimensional representations that capture temporal and relational characteristics of resource behavior. The temporal characteristics correspond to time-dependent variations in operational parameters, while the relational characteristics correspond to dependencies and interactions among the cloud computing resources.

In one embodiment, the behavioral representations are generated using one or more machine learning models including a graph neural network, a recurrent neural network, and an attention-based model. The graph neural network models inter-resource dependencies by representing resources and their interactions in a graph structure. The recurrent neural network captures sequential and time-dependent behavior of the operational data. The attention-based model prioritizes relevant features within the operational data to improve representation accuracy.

The generation of behavioral representations further comprises a multi-stage processing pipeline in which raw operational data is pre-processed into structured feature representations using feature extraction techniques applied to performance metrics, communication patterns, and execution characteristics. The extracted features are aggregated across temporal windows and across multiple cloud resources to capture inter-resource relationships and time-dependent behavioral variations. The aggregated feature representations are processed using machine learning models to generate continuous behavioral fingerprints corresponding to the cloud computing resources, the behavioral fingerprints encoding both current operational state and historical behavior patterns.

In one embodiment, the behavioral representations enable identification and characterization of previously unseen resource configurations and operational patterns by analyzing relational and temporal dependencies within the cloud computing environment. The system is configured to generalize learned behavioral models to novel infrastructure states without requiring predefined configuration templates.

The one or more processors 104 are further configured to detect anomalies in the cloud computing environment by identifying deviations between current operational behavior and the generated behavioral representations using one or more machine learning models. In one embodiment, the anomalies include transient anomalies corresponding to sudden changes in resource behavior, progressive anomalies corresponding to gradual deviations over time, and structural anomalies corresponding to abnormal interaction patterns among the cloud computing resources.

The one or more processors 104 are further configured to predict resource demand associated with the plurality of cloud computing resources based on the behavioral representations. The prediction of resource demand is performed using historical operational data and learned temporal behavior patterns to forecast future workload conditions. In one embodiment, anomaly detection is performed using dynamically calibrated evaluation criteria based on historical operational data, workload characteristics, and resource criticality. The system adjusts sensitivity levels for anomaly detection and remediation triggering based on contextual parameters including resource type, workload behavior, and system state, thereby reducing false positives and improving detection accuracy.

Based on the predicted resource demand, the one or more processors 104 dynamically allocate computing resources within the cloud computing environment. The dynamic allocation includes adjusting processing capacity, memory allocation, and network bandwidth, as well as distributing workloads across multiple cloud service providers or geographic regions to optimize system performance and resource utilization.

In response to detected anomalies, the one or more processors 104 automatically initiate remediation actions. The remediation actions include restarting services, reallocating computing resources, modifying system configurations, and isolating compromised resources. In one embodiment, automatic initiation of remediation actions includes determining a root cause of a detected anomaly, generating one or more remediation strategies, and executing a selected remediation strategy based on predicted effectiveness.

In one embodiment, the system 100 further includes a federated learning module configured to train machine learning models locally within multiple distributed cloud environments and update a global model using aggregated model parameters without transferring raw operational data. This enables collaborative learning across distributed systems while preserving data privacy.

In one embodiment, the behavioral representations are continuously updated in real time based on incoming operational data, thereby enabling the system 100 to adapt dynamically to changing system conditions and maintain accurate representations of cloud resource behavior. In one embodiment, the computing device 102 is communicatively coupled to one or more servers 108 via a network 110, including at least one of a local area network, wide area network, or cloud-based communication network.

In one embodiment, a method for autonomous management of a cloud computing environment is provided. The method includes collecting operational data from a plurality of cloud computing resources. The method further includes generating behavioral representations of the cloud computing resources based on the operational data, wherein the behavioral representations capture temporal and relational characteristics of resource behavior. The method further includes detecting anomalies by identifying deviations between current operational behavior and the behavioral representations. The method further includes predicting resource demand based on the behavioral representations and dynamically allocating computing resources based on the predicted resource demand. The method further includes automatically performing remediation actions in response to detected anomalies.

In one embodiment, generating the behavioral representations includes modeling temporal and relational characteristics of the cloud computing resources. In one embodiment, detecting anomalies includes analyzing operational behavior across multiple time scales. In one embodiment, performing remediation actions includes executing corrective actions without human intervention.

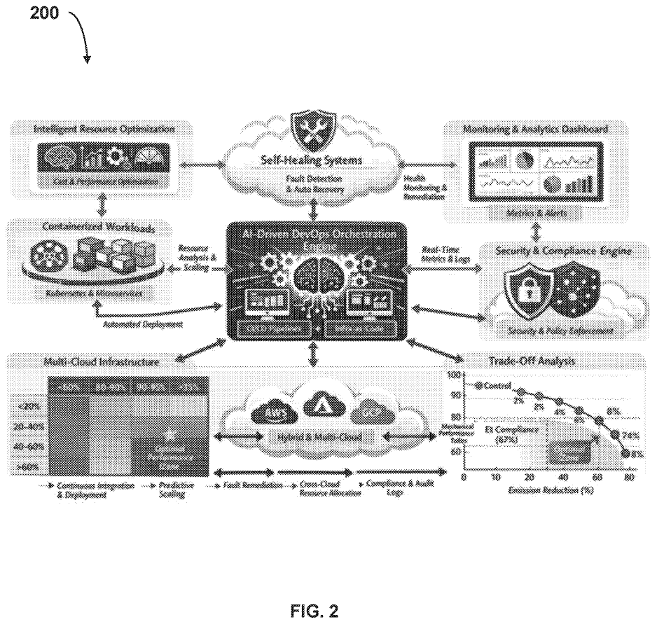

FIG. 2 refers to an autonomous cloud platform architecture 200 for managing cloud computing resources using artificial intelligence-driven orchestration, optimization, monitoring, and self-healing mechanisms. At the core of the architecture is an AI-driven DevOps orchestration engine, which functions as a central control layer configured to coordinate deployment, monitoring, optimization, and remediation operations across the cloud environment. The orchestration engine interfaces with infrastructure automation mechanisms including continuous integration/continuous deployment pipelines and infrastructure-as-code frameworks to enable automated provisioning and configuration of resources.

The orchestration engine is operatively coupled to a containerized workload layer, which includes microservices-based applications deployed using container orchestration platforms. The containerized workloads are dynamically managed based on resource analysis and scaling operations performed by the orchestration engine. An intelligent resource optimization module is configured to analyze cost and performance parameters associated with cloud resources. This module performs optimization operations to maintain system performance within a defined optimal zone by adjusting resource allocation and scaling parameters.

A self-healing system is integrated within the architecture and is configured to perform fault detection and automated recovery. The self-healing system receives operational data from the orchestration engine and initiates remediation actions to restore system functionality in response to detected anomalies. A monitoring and analytics dashboard is configured to process operational data including metrics and alerts generated from the cloud environment. The dashboard provides real-time visualization of system health, performance trends, and anomaly indicators.

A security and compliance engine is configured to enforce security policies and monitor compliance conditions. The security and compliance engine processes real-time logs and metrics to detect security events and ensure adherence to defined policies. The architecture 200 further includes a multi-cloud infrastructure layer, comprising distributed cloud platforms across multiple service providers. This layer supports hybrid and multi-cloud deployment models and enables cross-cloud resource allocation and workload distribution. A trade-off analysis module is configured to evaluate system performance based on multiple parameters including cost, efficiency, and operational constraints. The module identifies an optimal operating region by balancing performance metrics against system objectives.

Data flow within the architecture includes transmission of real-time metrics, logs, resource signals, and control instructions between the orchestration engine and associated modules. The architecture supports continuous integration and deployment, predictive scaling, fault remediation, cross-cloud resource allocation, and compliance auditing, forming a closed-loop system for autonomous cloud management.

In one embodiment, the resource optimization module operates using a hierarchical optimization framework comprising multiple levels of optimization. At a first level, individual cloud resources are optimized by adjusting parameters including processing capacity, memory allocation, and network bandwidth. At a second level, service clusters and application components are dynamically scaled based on predicted workload demand. At a third level, workloads are distributed across multiple cloud environments, geographic regions, or service providers based on cost, performance, and policy constraints. This hierarchical optimization enables coordinated resource management across the cloud infrastructure.

In one embodiment, the security and compliance engine performs behavioral analysis of cloud resources by comparing real-time operational patterns with expected behavioral representations to detect anomalous activity. The system further analyzes interaction patterns among cloud resources to identify abnormal communication flows indicative of unauthorized access or lateral movement within the cloud environment. Based on detected anomalies, the system performs security response actions including isolation of affected resources, modification of access controls, and generation of security alerts and incident reports.

In one embodiment, the system maintains a persistent record of operational decisions including anomaly detection events, resource allocation actions, remediation strategies, and execution outcomes. The recorded data is stored in a structured format to enable querying, auditing, and forensic analysis of system behavior and management decisions. In one embodiment, communication between system components is secured using advanced encryption mechanisms, including quantum-resistant cryptographic protocols, to ensure integrity and confidentiality of operational data transmitted across the cloud infrastructure.

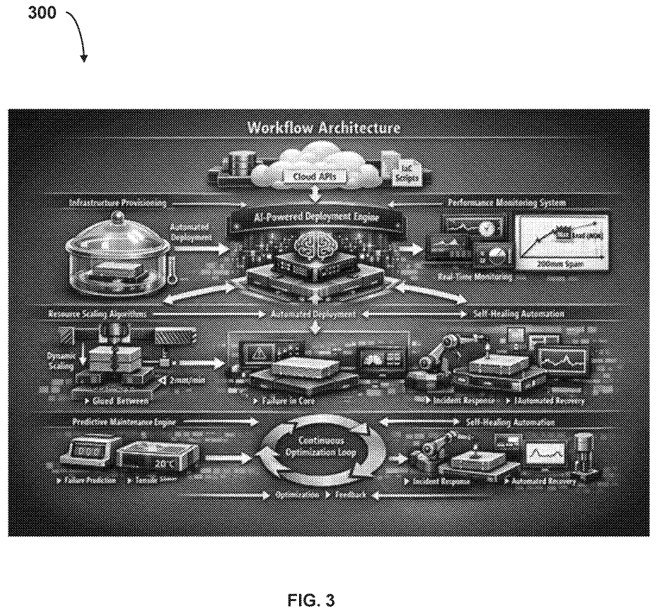

FIG. 3 refers to a workflow architecture 300 depicting data flow and operational processes for infrastructure provisioning, monitoring, anomaly detection, optimization, and automated remediation within the cloud computing environment. The workflow is initiated through an infrastructure provisioning stage, in which cloud resources are instantiated using cloud-based interfaces, including cloud application programming interfaces and infrastructure-as-code scripts. The provisioning stage enables automated deployment of computing resources within the cloud environment.

An AI-powered deployment engine is configured to manage deployment operations, including orchestration of application services and allocation of infrastructure resources. The deployment engine processes inputs from the provisioning stage and coordinates automated deployment of workloads. The deployed resources are continuously observed by a performance monitoring system, which performs real-time monitoring of operational parameters including system load, performance metrics, and execution characteristics. The monitoring system generates operational data streams that are provided to downstream processing components.

A resource scaling module operates in conjunction with the monitoring system to perform dynamic scaling operations. The module adjusts resource allocation in response to detected workload variations, enabling adaptive scaling of processing capacity, memory, and network resources. The workflow further includes a self-healing automation component configured to detect failures within the system. Upon detection of a failure condition, an incident response process is triggered, followed by execution of automated recovery actions to restore system functionality.

A predictive maintenance module is configured to analyze historical operational data and system behavior patterns to forecast potential failures. The predictive maintenance module supports early detection of system degradation and enables preemptive corrective actions. The workflow is governed by a continuous optimization loop, which integrates outputs from monitoring, scaling, predictive maintenance, and self-healing processes. The optimization loop performs iterative refinement of system performance through feedback-driven adjustments to resource allocation, deployment strategies, and remediation actions. Data flows within the workflow include transmission of operational metrics, deployment instructions, scaling signals, and feedback information among the various components. The workflow operates as a closed-loop system, enabling continuous monitoring, analysis, decision-making, and execution of actions for autonomous cloud infrastructure management.

In one embodiment, the self-healing automation component operates as a closed-loop control system comprising a detection phase, a diagnosis phase, a planning phase, an execution phase, and a verification phase. The detection phase identifies anomalies in operational behavior. The diagnosis phase determines root causes of detected anomalies based on dependency analysis. The planning phase generates one or more remediation strategies. The execution phase implements selected corrective actions. The verification phase evaluates post-remediation system behavior to confirm effectiveness of the corrective actions.

In one embodiment, remediation actions are executed in a staged manner with intermediate monitoring to evaluate system response. The system further maintains rollback capability to revert to a previous system state in the event that a remediation action produces unintended effects. In one embodiment, outputs from the verification phase are incorporated into the continuous optimization loop to refine behavioral models, improve anomaly detection accuracy, and enhance future remediation strategies.

In one embodiment, the federated learning module performs periodic aggregation of locally trained model parameters from multiple distributed cloud environments. The aggregated model parameters are processed to generate updated global models, which are subsequently distributed back to the distributed environments. This process enables continuous improvement of machine learning models based on collective system experience while preserving confidentiality of local operational data.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A system for autonomous management of a cloud computing environment, comprising:
a computing device having a processor and a memory for storing one or more instruction executable by the processor,
wherein the processor is configured to:
collect operational data from a plurality of cloud computing resources, the operational data including performance metrics, communication patterns, and execution characteristics;
generate, based on the operational data, behavioral representations of the plurality of cloud computing resources, the behavioral representations capturing temporal and relational characteristics of the cloud computing resources;
detect anomalies in the cloud computing environment by identifying deviations between current operational behavior and the behavioral representations using one or more machine learning models;
predict resource demand associated with the plurality of cloud computing resources based on the behavioral representations;
dynamically allocate computing resources in the cloud computing environment based on the predicted resource demand; and
automatically initiate remediation actions in response to the detected anomalies,
wherein the behavioral representations enable improved utilization of computing resources and reduced response latency in the cloud computing environment.

2. The system of claim 1, wherein the wherein generating the behavioral representations comprises processing the operational data using at least one of a graph neural network configured to model inter-resource dependencies, a recurrent neural network configured to capture temporal patterns, and an attention-based model configured to prioritize relevant operational features.

3. The system of claim 1, wherein the detecting anomalies comprises identifying at least one of a transient anomaly corresponding to a sudden change in resource behavior, a progressive anomaly corresponding to a gradual deviation over time, and a structural anomaly corresponding to abnormal interaction patterns among the plurality of cloud computing resources.

4. The system of claim 1, wherein predicting resource demand comprises forecasting future workload conditions using historical operational data and temporal behavior patterns.

5. The system of claim 1, wherein dynamically allocating computing resources comprises:
adjusting processing capacity, memory allocation, or network bandwidth; and
distributing workloads across multiple cloud service providers or geographic regions.

6. The system of claim 1, wherein the remediation actions comprise at least one of restarting a service, reallocating computing resources, modifying system configurations, and isolating a compromised resource.

7. The system of claim 1, wherein automatically initiating remediation actions comprises:
determining a root cause of a detected anomaly;
generating one or more remediation strategies; and
executing a selected remediation strategy based on predicted effectiveness.

8. The system of claim 1, further comprising a federated learning module configured to:
train machine learning models locally within multiple distributed cloud environments; and
update a global model using aggregated model parameters without transferring raw operational data.

9. The system of claim 1, wherein the behavioral representations are continuously updated in real time based on incoming operational data.

10. The system of claim 1, wherein the computing device is communicatively coupled to a server via a network.

11. A method for autonomous management of a cloud computing environment, comprising:
collecting operational data from a plurality of cloud computing resources;
generating behavioral representations of the plurality of cloud computing resources based on the operational data;
detecting anomalies by identifying deviations between current behavior and the behavioral representations;
predicting resource demand based on the behavioral representations;
dynamically allocating computing resources based on the predicted resource demand; and
automatically performing remediation actions in response to detected anomalies.

12. The method of claim 11, wherein generating the behavioral representations comprises modeling temporal and relational characteristics of the cloud computing resources.

13. The method of claim 11, wherein detecting anomalies comprises analyzing behavior across multiple time scales.

14. The method of claim 11, wherein performing remediation actions comprises executing corrective actions without human intervention.
